(19) United States
(12) Patent Application Publication
(10) Pub. No.: US 2025/0041841 A1
(43) Pub. Date: Feb. 6, 2025

(54) PHOTOCATALYST COATING AGENT, PHOTOCATALYST COATED BODY, AND PHOTOCATALYST COATING METHOD

(71) Applicant: SHARP KABUSHIKI KAISHA, Sakai City (JP)

(72) Inventors: YOSHITAKA KAWASE, Sakai City, (JP); NAOKI SHIBA, Sakai City (JP); TOMOYA TSUTSUMINO, Sakai City (JP); TATSUFUMI ATSUMI, Sakai City (JP); Yoshiki KATO, Sakai City (JP)

(21) Appl. No.: 18/777,603

(22) Filed: Jul. 19, 2024

(30) Foreign Application Priority Data
Aug. 4, 2023 (JP) 2023-128013

(51) Int. Cl. B01J 35/39; B01J 23/30; B01J 37/02

(52) U.S. Cl. CPC B01J 35/39; B01J 23/30; B01J 37/0219; B01J 37/0221

(57) ABSTRACT

The present disclosure provides a photocatalyst coating agent capable of forming a photocatalyst layer having excellent water resistance and durability while maintaining photocatalytic activities. The photocatalyst coating agent of the present disclosure comprises at least: photocatalyst particles containing tungsten oxide; a first binder; and water, wherein the first binder is 1,2-bis(trihydroxysilyl)alkane represented by a chemical formula: (HO)₃Si—(CH₂)ₙ—Si(OH)₃.

### BACKGROUND OF THE INVENTION

### Field of the Invention

The present disclosure relates to a photocatalyst coating agent, a photocatalyst coated body, and a photocatalyst coating method.

### Description of the Background Art

Photocatalyst particles exhibit photocatalytic activities when exposed to light. Utilizing the photocatalytic activities, the photocatalyst particles can perform, for example, the following functions: decomposing airborne toxic substances; decomposing odor-causing substances; decomposing pollutants dissolved or dispersed in water; decomposing fungi; inhibiting fungus growth; and preventing stains on exterior walls or windows.

In order to utilize the photocatalytic activities, the photocatalyst particles need to be fixed (bonded) to a base material. For example, Patent Literature WO 2011/059101 A1 discloses an antifouling acrylic board comprising: an acrylic base material; a silica layer formed on a surface of the acrylic base material; and a photocatalyst layer formed on a surface of the silica layer. Between the surface of the acrylic base material and the silica layer is a binding layer containing a silane coupling agent.

### SUMMARY OF THE INVENTION

In the acrylic board disclosed in the Patent Literature, the base material and the silica layer are bonded simply by the silane coupling agent; and this was insufficient to improve water resistance and durability of the photocatalyst layer (photocatalyst film).

The present disclosure was made in view of these problems, and provides a photocatalyst coating agent capable of forming a photocatalyst layer having excellent water resistance and durability while maintaining photocatalytic activities.

The present disclosure provides a photocatalyst coating agent comprising at least: photocatalyst particles containing tungsten oxide; a first binder; and water, wherein the first binder is 1,2-bis(trihydroxysilyl)alkane represented by (HO)₃Si—(CH₂)ₙ—Si(OH)₃.

The photocatalyst coating agent of the present disclosure can form a photocatalyst layer having excellent water resistance and durability as well as maintaining photocatalytic activities.

### BRIEF DESCRIPTION OF THE DRAWING

FIG. 1 is an explanatory diagram of how to form a photocatalyst coated body by using a photocatalyst coating agent in accordance with one Embodiment of the present disclosure.

FIG. 2 is Table 1 showing compositions of the photocatalyst coating agents.

FIG. 3 is Table 2 showing evaluations of the photocatalyst coating agents and photocatalyst bodies.

### DESCRIPTION OF THE PREFERRED EMBODIMENTS

A photocatalyst coating agent of the present disclosure is characterized by comprising at least: photocatalyst particles containing tungsten oxide; a first binder; and water, wherein the first binder is 1,2-bis(trihydroxysilyl)alkane represented by a chemical formula: (HO)₃Si—(CH₂)ₙ—Si(OH)₃.

It is preferable that the content percentage of the photocatalyst particles should be 50 mass % or more to 99 mass % or less when the mass of a total solid content in the photocatalyst coating agent is 100 mass %.

It is preferable that the content percentage of the first binder should be 1 mass % or more to 50 mass % or less when the mass of the total solid content in the photocatalyst coating agent is 100 mass %.

It is preferable that the first binder should be 1,2-bis(trihydroxysilyl)alkane in which the number of carbon atoms n is 2 to 8.

It is preferable that the photocatalyst coating agent of the present disclosure should further comprise a second binder; and it is preferable that the second binder should be a compound having a hydroxysilyl group.

It is preferable that the second binder should be a compound having a methacryloxy group.

It is preferable that the sum of the content percentage of the first binder and the content percentage of the second binder should be 1 mass % or more to 50 mass % or less when the mass of the total solid content in the photocatalyst coating agent is 100 mass %.

It is preferable that the photocatalyst coating agent of the present disclosure should further comprise an antiseptic, and it is preferable that the antiseptic should be ethanol. The photocatalyst coating agent containing ethanol is capable of increasing an antiseptic effect.

It is preferable that the photocatalyst coating agent should be a suspension containing the first binder, the photocatalyst particles, and water.

The present disclosure also provides a photocatalyst coated body provided with a base material and a photocatalyst layer placed on the base material. The photocatalyst layer in the photocatalyst coated body contains photocatalyst particles and a siloxane compound containing a product of dehydration-condensation reaction of 1,2-bis(trihydroxysilyl)alkane represented by a chemical formula: (HO)₃Si—(CH₂)ₙ—Si(OH)₃.

The present disclosure also provides a photocatalyst coating method comprising: applying the photocatalyst coating agent of the present disclosure onto a base material to form an application layer; and allowing the application layer to dry.

Hereinafter, the present disclosure will be described in detail with reference to Embodiments. Structures shown in the drawing or described below should be recognized as exemplifications, and the scope of the present disclosure is not limited to the drawing and the following descriptions.

### Embodiment 1: Photocatalyst Coating Agent

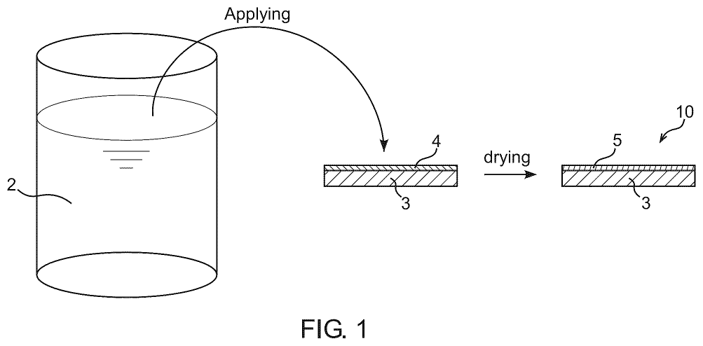

FIG. 1 illustrates a method for forming a photocatalyst coated body using a photocatalyst coating agent in accordance with the present Embodiment.

Embodiment 1 of the present disclosure relates to a photocatalyst coating agent 2 (hereinafter sometimes referred to as a “coating agent 2”).

The photocatalyst coating agent 2 in accordance with the present Embodiment contains at least the following elements: photocatalyst particles comprising tungsten oxide; a first binder; and water, wherein the first binder is 1,2-bis(trihydroxysilyl)alkane represented by a chemical formula: (HO)₃Si—(CH₂)ₙ—Si(OH)₃. The photocatalyst coating agent 2 may be a suspension comprising the first binder, the photocatalyst particles, and water.

The photocatalyst coating agent 2 in accordance with the present Embodiment is applied to a base material 3, and an application layer 4 thereby obtained is allowed to dry so as to form a photocatalyst layer 5.

The coating agent 2 may further contain an antiseptic, if necessary. The coating agent 2 in accordance with Embodiment 1 is a water-based coating agent containing water. A solvent (or a dispersion medium) for the coating agent 2 is water, a mixture of water and ethanol, or the like. Such a coating agent is capable of reducing environmental load and improving working environment.

A binder (including the first binder) in the photocatalyst coating agent 2 becomes a siloxane compound (a binder) in the photocatalyst layer 5 and binds the base material 3, to which the coating agent 2 is applied, to the photocatalyst particles mainly containing tungsten oxide. The siloxane compound (the binder) binds the photocatalyst particles to each other, which are contained in the photocatalyst layer 5. The coating agent 2 may comprise one type of binder (for example, may comprise only the first binder) or multiple types of binders (for example, may comprise the first binder and a second binder). The coating agent 2 comprises, as the first binder, a 1,2-bis(trihydroxysilyl)alkane (chemical formula of (HO)₃Si—(CH₂)ₙ—Si(OH)₃). The 1,2-bis(trihydroxysilyl)alkane in the coating agent 2 may be bonded to the photocatalyst particles by a dehydration-condensation reaction. Also, a plurality of 1,2-bis(trihydroxysilyl)alkanes in the coating agent 2 may be bonded together by a dehydration-condensation reaction.

1,2-Bis(trihydroxysilyl)alkane has an alkane skeleton structure (CH₂)ₙ between two silicon atoms, each silicon atom being bonded to three hydroxyl groups (OH). This compound can be obtained by hydrolyzing 1,2-bis(trialkoxysilyl)alkane (chemical formula: (CₘH₂ₘ₊₁O)₃Si—(CH₂)ₙ—Si(OCₘH₂ₘ₊₁)₃). The number of carbon atoms “n” should preferably be 2 to 8. The alkoxy group (CₘH₂ₘ₊₁O—) may be, for example, an ethoxy group (C₂H₅O—) and becomes a hydroxyl group (—OH) by a hydrolysis reaction.

The alkane skeleton structure in 1,2-bis(trihydroxysilyl)alkanes is, for example, ethane (—(CH₂)₂—), hexane (—(CH₂)₆—), or octane (—(CH₂)₈—).

The coating agent 2 is capable of having the following four advantages (First to Fourth Advantages) by comprising 1,2-bis(trihydroxysilyl)alkane as the first binder.

Firstly, First Advantage will be described. When the application layer 4 dries, which is formed from the coating agent 2 applied to the base material 3, a part of the silanol group (SiOH) of this first binder and a hydroxy group (OH) on a surface of the base material 3 are dehydrated and condensed, thereby forming a covalent bond between this first binder (or a product of dehydration-condensation reaction of the first binder) and the base material 3. Also, a part of the silanol group (SiOH) of this first binder (or a product of dehydration-condensation reaction of the first binder) and a hydroxy group (OH) on surfaces of the photocatalyst particles that mainly comprise tungsten oxide are dehydrated and condensed, thereby forming a covalent bond between the first binder (or a product of dehydration-condensation reaction of the first binder) and the photocatalyst particles that mainly comprise tungsten oxide. Because these dehydration-condensation reactions are induced when the application layer 4 dries, which is made of the coating agent 2 applied to the base material 3, the photocatalyst particles, which comprise tungsten oxide as the main constituent, can be firmly bonded to the base material 3 through the siloxane compound containing the product of dehydration-condensation reactions of 1,2-bis(trihydroxysilyl)alkane. Such strong bonding can improve water resistance and durability of the photocatalyst layer 5, which is formed from the coating agent 2.

The 1,2-bis(trihydroxysilyl)alkane is readily bonded to metal particles and metal oxide particles as well as to the base material 3 made of, for example, metal, metal oxide, glass, or plastic, allowing for strong adhesion (bonding) between the photocatalyst particles and a surface of various base materials. Therefore, only a small amount of the binder is needed for the coating film formation, compared to an amount of the photocatalyst particles; and a photocatalytic function of the photocatalyst particles would not be impaired (would remain intact).

Secondly, Second Advantage will be described. When the application layer 4 dries, which is formed from the coating agent 2 applied to the base material 3, parts of the silanol groups of the 1,2-bis(trihydroxysilyl)alkane molecules are dehydrated and condensed to each other, allowing the 1,2-bis(trihydroxysilyl)alkane molecules to bond to each other and generating a siloxane compound. In this way, when the application layer 4 dries, which is formed from the coating agent 2 applied to the base material, and the 1,2-bis(trihydroxysilyl)alkane molecules bonded with each other generate the siloxane compound, the photocatalyst particles, which mainly comprise tungsten oxide, can be more tightly bonded to the base material 3 via the siloxane compound functioning as the binder. Their tight bonding improves water resistance and durability of the photocatalyst layer 5 formed from the coating agent 2.

Thirdly, Third Advantage will be described. The 1,2-bis(trihydroxysilyl)alkane has six hydroxy groups per molecule, thereby increasing its affinity for water. The higher affinity for water makes the 1,2-bis(trihydroxysilyl)alkane easier to blend (mix) with water-based coating agents containing water.

Fourthly, Fourth Advantage will be described. In general, when the application layer 4 dries, which is formed of the coating agent 2 applied to the base material 3, a dehydration-condensation reaction is induced among the 1,2-bis(trihydroxysilyl)alkane, the base material 3, and the photocatalyst particles comprising mainly tungsten oxide. This reduces time required to produce a photocatalyst coated body 10, which will be described later in Embodiment 3.

1,2-Bis(trihydroxysilyl)alkane (chemical formula of (HO)₃Si—(CH₂)ₙ—Si(OH)₃) can be obtained by hydrolyzing 1,2-bis(trialkoxysilyl)alkane (chemical formula: (RO)₃Si—(CH₂)ₙ—Si(OR)₃ wherein R═CH₃, CH₂CH₃, or the like) in an acidic solvent to remove alcohol. Since 1,2-bis(trialkoxysilyl)alkane is not water-soluble, but hydrolysate is water-soluble, it is possible to visually confirm whether hydrolysis is complete.

Ethylene groups (—(CH₂)₂—), hexamethylene groups (—(CH₂)₆—), and octamethylene groups (—(CH₂)₈—) are preferred as an alkane skeleton structure of 1,2-bis(trihydroxysilyl)alkane or 1,2-bis(trialkoxysilyl)alkane; and of these groups, the ethylene groups are more preferable due to their water solubility. Of the alkoxy groups represented by RO in 1,2-bis(trialkoxysilyl)alkane, an alkoxy group having 1 to 6 carbon atoms is preferable; an alkoxy group having 1 to 3 carbon atoms is more preferable; and a methoxy group or an ethoxy group is further preferable.

To increase adhesivity (bonding), the coating agent 2 may contain, as the second binder, a compound having a hydroxysilyl group different from the first binder, as well as 1,2-bis(trihydroxysilyl)alkane (the first binder). By including the second hydroxysilyl group-containing binder (the second binder) in the coating agent 2, the binder (the siloxane compound) and the photocatalyst in the photocatalyst layer 5 can be more firmly bonded three dimensionally to the base material 3 in the photocatalyst coated body 10; and the adhesivity of the photocatalyst layer 5 to the base material 3 can be increased.

The compound with the hydroxysilyl group, as the second binder, should preferably have a methacryloxy group. The second binder has the hydroxysilyl group; therefore, when the application layer 4 formed by applying the coating agent 2 to the base material 3 dries, the second binder is involved in the dehydration-condensation reaction together with the first binder, thereby forming the siloxane compound (the binder) containing a product of dehydration-condensation reaction of the first binder and a product of dehydration-condensation reaction of the second binder.

Examples of the second binder include vinyl-type vinyltrihydroxysilanes, 3-aminopropyltrihydroxysilane, 3-glycidoxypropyltrihydroxysilane, 3-methacryloxypropyltrihydroxysilane, and 3-mercaptopropyltrihydroxysilane.

The second binder in the coating agent 2 may be bonded to the photocatalyst particles by a dehydration-condensation reaction. A plurality of the second binders in the coating agent 2 may be bonded to each other by a dehydration-condensation reaction. The second binder in the coating agent 2 may be bonded to the first binder (1,2-bis(trihydroxysilyl)alkane) by a dehydration-condensation reaction.

The ratio (B/A) of a mass (B) of the second binder to a mass (A) of the first binder in the coating agent 2 can be from (20/80) or more to (80/20) or less.

To improve water resistance and durability of the photocatalyst layer 5 while keeping photocatalytic activities of the photocatalyst layer 5, the content percentage of a binder component (which may include the second binder) containing 1,2-bis(trihydroxysilyl)alkane (the first binder) in the coating agent 2 should be preferably 1 mass % (% by mass) or more to 50 mass % or less when the mass of a total solid content in the coating agent 2 is 100 mass %. The materials in the total solid content in the coating agent 2 refer to components in the coating agent 2 that exclude the dispersion medium and the solvent (such as water, ethanol, or the like).

To especially improve the photocatalytic activities of the photocatalyst layer 5 while improving the water resistance and the durability of the photocatalyst layer 5, when the mass of the total solids contained in the coating agent 2 is 100 mass %, the content percentage of the binder component (which may include the second binder) containing 1,2-bis(trihydroxysilyl)alkane (the first binder) in the coating agent 2 is preferably 1.0 mass % or more to 20 mass % or less. The following two factors make it possible that the photocatalyst particles, which mainly comprise tungsten oxide, are strongly covalently bonded to the base material 3 via a siloxane compound containing a product of dehydration-condensation reaction of 1,2-bis(trihydroxysilyl)alkane: (1) the binder component containing 1,2-bis(trihydroxysilyl)alkane or a product of dehydration-condensation reaction of 1,2-bis(trihydroxysilyl)alkane is dehydrated and condensed with the tungsten oxide-based photocatalyst particles; and (2) the binder component containing 1,2-bis(trihydroxysilyl)alkane or a product of dehydration-condensation reaction of 1,2-bis(trihydroxysilyl)alkane is dehydrated and condensed with the base material 3. This allows strong bonding between the tungsten oxide-based photocatalyst particles and the base material 3 via the siloxane compound (the binder) even if the content percentage of the binder component containing 1,2-bis(trihydroxysilyl)alkane in the coating agent 2 is low. This thus makes it possible to reduce an amount of 1,2-bis(trihydroxysilyl)alkane to be added, which is the binder in the coating agent 2. This prevents the photocatalytic activities of the photocatalyst layer 5 from being depressed by the siloxane compound, which is the binder, and also prevents the photocatalyst particles from being buried (embedded) in the siloxane compound, which is the binder. As a result, the photocatalytic activities of the photocatalyst layer 5 can be especially improved while improving the water resistance and the durability of the photocatalyst layer 5.

Photocatalyst Particles Comprising Tungsten Oxide as Main Content

The photocatalyst particles, which comprise tungsten oxide as a main content, have photocatalytic activities in a short wavelength region of visible light. More specifically, when the photocatalyst particles are irradiated with light having an energy higher than an energy gap between a valence band and a conduction band, electrons in the valence band of the photocatalyst particles excite the conduction band; and holes are generated in the valence band. These electrons and holes move inside the photocatalyst particles. The electrons reduce oxygen gas, resulting in the generation of superoxide anions. The holes oxidize water, resulting in the generation of hydroxyl radicals. The hydroxyl radicals thereby generated produce reactive oxygen species. The produced reactive oxygen species achieve, for example, decomposition of harmful substances and antibacterial and antifouling actions.

The tungsten oxide is not particularly limited, and commercially available tungsten oxide can be used as needed. Examples of the tungsten oxide include WO₃ (tungsten trioxide), WO₂, WO, W₂O₃, W₄O₅, W₄O₁₁, W₂₅O₇₃, W₂₀O₅₈, and W₂₄O₆₈, and mixtures of these tungsten oxides. To improve the photocatalytic activities of the photocatalyst layer 5, WO₃ is preferred as the tungsten oxide. A part of the tungsten atoms in the tungsten oxide may be reduced to a pentavalent. However, it is preferable to oxidize the tungsten atoms in the tungsten oxide to a hexavalent before use. A method for oxidizing the tungsten atoms in the tungsten oxide to the hexavalent includes, for example, a method for sintering tungsten oxide at high temperature. A crystal structure of the tungsten oxide is not particularly limited.

The average particle diameter of the photocatalyst particles, which are mainly made of tungsten oxide, is preferably 5 nm or more to 200 nm or less. This makes the photocatalyst particles less likely to agglomerate and makes the photocatalyst particles more likely to re-disperse. When the average particle diameter of the photocatalyst particles is 200 nm or less, the photocatalyst particles tend to mix uniformly with other coating materials in the coating agent, and the release of the photocatalyst particles from the photocatalyst layer 5 formed from the coating agent 2 can be prevented. The average particle diameter is a value calculated based on a specific surface area (unit: m²/g) of the particles measured by the BET method, on the assumption that the primary particles are spherical.

The tungsten oxide-based photocatalyst particles may have co-catalyst particles on surfaces thereof. As the co-catalyst particles, metal particles are preferred, transition metal particles are more preferred, and platinum group metal particles are even more preferred. The platinum group metal particles may be made of, for example, Pt, Pd, Rh, Ru, Os, or Ir. The co-catalyst particles on the surfaces of the tungsten oxide particles can make an energy gap smaller between a valence band and a conduction band of the tungsten oxide particles, thereby improving photoresponse in a visible light region.

When the mass of a total solid content in the coating agent 2 is 100 mass %, the content percentage of the photocatalyst particles in the coating agent 2, which are mainly made of tungsten oxide, is preferably 50 mass % or more to 99 mass % or less, and more preferably 20 mass % or more to 99 mass % or less. When the application layer 4 dries, 1,2-bis(trihydroxysilyl)alkane or a product of dehydration-condensation reaction of 1,2-bis(trihydroxysilyl)alkane is dehydrated and condensed with the photocatalyst particles, and the 1,2-bis(trihydroxysilyl)alkane or a product of dehydration-condensation reaction of 1,2-bis(trihydroxysilyl)alkane is dehydrated and condensed with the base material 3, with the result that the photocatalyst particles are strongly bonded to the base material 3 through the siloxane compound (the binder) containing the product of dehydration-condensation reaction of the 1,2-bis(trihydroxysilyl)alkane. Therefore, even if the content percentage of the photocatalyst particles is high (in other words, the content percentage of the binder is low) in the photocatalyst layer 5, the photocatalyst particles and the base material 3 are strongly bonded to each other through the binder (the siloxane compound). This allows for the reduction of an amount of 1,2-bis(trihydroxysilyl)alkane, which is the binder, to be added to the coating agent 2. This prevents photocatalytic activities of the photocatalyst layer 5 from being depressed by the siloxane compound (the binder), and also prevents the photocatalyst particles from being buried (embedded) in the siloxane compound (the binder). As a result, the photocatalytic activities of the photocatalyst layer 5 can be particularly enhanced while improving the water resistance and the durability of the photocatalyst layer 5.

### Antiseptic

It is preferable that the coating agent 2 should further contain an antiseptic in addition to the photocatalyst particles (which mainly comprise tungsten oxide), the binder, and water. As the antiseptic, the following may be used: ethanol; a component such as alkanediol with 3 to 6 carbon atoms (for example, 1,3-propanediol, 1,2-pentanediol, 1,2-hexanediol, or 4-oxa-2,6-heptanediol); a water-soluble copper compound (for example, copper gluconate, copper sulfate, copper chloride, copper nitrate, copper acetate, copper lactate, or copper butyrate); or a water-soluble silver compound (for example, silver nitrate, silver oxide, silver sulfate, silver chloride, silver sulfite, silver carbonate, silver acetate, or silver lactate).

### Embodiment 2: Method for Preparing Coating Agent

Embodiment 2 of the present disclosure relates to a method for preparing a coating agent 2. The coating agent 2 produced by the preparation method of Embodiment 2 is the coating agent 2 of Embodiment 1. A photocatalyst layer 5 formed using the coating agent 2 produced by the preparation method of Embodiment 2 has excellent water resistance and durability while maintaining photocatalytic activities, for the same reasons described in Embodiment 1. The method of Embodiment 2 for preparing the coating agent 2 comprises, for example, the coating agent preparation step.

### Coating Agent Preparation Step

In the coating agent preparation step, the following are mixed to obtain a coating agent 2 of Embodiment 1: a binder containing 1,2-bis(trihydroxysilyl)alkane (a first binder) (which may also contain a second binder); photocatalyst particles mainly made of tungsten oxide; and water. To improve dispersibility, it is preferable to mix 1,2-bis(trihydroxysilyl)alkane with the tungsten oxide-based photocatalyst particles. The tungsten oxide-based photocatalyst particles may be added in the form of a photocatalyst dispersion liquid containing the photocatalyst particles and a dispersion medium.

The binder containing 1,2-bis(trihydroxysilyl)alkane may be obtained by hydrolyzing the alkoxy group by mixing a binder liquid containing 1,2-bis(trialkoxysilyl)alkane and a solvent with the photocatalyst particles mainly made of tungsten oxide or by mixing the binder liquid with a dispersion liquid of the tungsten oxide-based photocatalyst particles, the tungsten oxide having an acidic property. Examples of the dispersion medium contained in the dispersion liquid of the photocatalyst particles include polar solvents and more specifically include water and ethanol. Examples of the solvent and the dispersion medium contained in the binder liquid include polar solvents and more specifically include water, methanol, ethanol, and propanol.

### Embodiment 3: Photocatalyst Coated Body and Method for Preparing the Same

Embodiment 3 of the present disclosure relates to a photocatalyst coated body and a method for preparing the same.

A photocatalyst coated body 10 has a base material 3 and a photocatalyst layer 5 provided on the base material 3, wherein the photocatalyst layer 5 comprises: photocatalyst particles; and a siloxane compound containing a product of dehydration-condensation reaction of 1,2-bis(trihydroxysilyl)alkane (a first binder) represented by a chemical formula: (HO)₃Si—(CH₂)ₙ—Si(OH)₃. The siloxane compound may contain a product of dehydration-condensation reaction of a second binder described above.

Examples of materials for the base material 3 (specifically, a support) include glass, plastic, metal, ceramics, wood, stone, cement, concrete, fiber, fabric, paper, and leather, and combinations of these materials. The base material 3 may be a laminate body formed of layers made of different materials. The materials for the base material 3 may have a hydroxyl group on surfaces thereof.

The coating agent 2 of Embodiment 1 contains 1,2-bis(trihydroxysilyl)alkane as the first binder. The base material 3 containing the material(s) as above allows 1,2-bis(trihydroxysilyl)alkane or a product of dehydration-condensation reaction of 1,2-bis(trihydroxysilyl)alkane to dehydrate and condense with the base material 3 so as to allow 1,2-bis(trihydroxysilyl)alkane or a product of dehydration-condensation reaction of 1,2-bis(trihydroxysilyl)alkane to dehydrate and condense with the photocatalyst particles. These dehydration-condensation reactions induce a covalent bond that allows the photocatalyst particles to be firmly bonded to the base material 3 via the binder (a siloxane compound).

The photocatalyst layer 5 included in the photocatalyst coated body 10 can be produced using the coating agent 2 of Embodiment 1. Because of using the coating agent 2 of Embodiment 1, the photocatalyst layer 5 included in the photocatalyst coated body 10 produced by the preparation method of Embodiment 3 is excellent in water resistance and durability while sustaining photocatalytic activities, for the same reasons described in Embodiment 1.

The photocatalyst layer 5 is disposed on the base material 3. The photocatalyst layer 5 may be disposed directly on the base material 3. Alternatively, a primer layer may be disposed on the base material 3 so as to be sandwiched between the photocatalyst layer 5 and the base material 3. The primer layer is formed of a primer.

The photocatalyst layer 5 contains: the photocatalyst particles; and the siloxane compound containing the product of dehydration-condensation reaction of 1,2-bis(trihydroxysilyl)alkane (the first binder) represented by a chemical formula: (HO)₃Si—(CH₂)ₙ—Si(OH)₃. The siloxane compound is a compound having a siloxane bond and is a compound containing a product of dehydration-condensation reaction of the first binder. The siloxane compound may contain the product of dehydration-condensation reaction of the first binder and the product of dehydration-condensation reaction of the second binder described above.

The method for preparing the photocatalyst coated body 10 of Embodiment 3 comprises, for example, the step of forming a photocatalyst layer.

### Step of Forming Photocatalyst Layer

In the photocatalyst layer formation step, the coating agent 2 of Embodiment 1 is applied on top of the base material 3 to form an application layer 4; and the application layer 4 is allowed to dry. This makes the photocatalyst particles bond to the base material 3 via a siloxane compound (a binder) containing a product of dehydration-condensation reaction of 1,2-bis(trihydroxysilyl)alkane. By allowing the application layer 4 to dry, at least some of water contained in the application layer 4 is removed. In this way, the photocatalyst layer 5 comprising the photocatalyst particles and the siloxane compound (the binder) containing the product of dehydration-condensation reaction of 1,2-bis(trihydroxysilyl)alkane is formed on the base material 3. Since the coating agent 2 of Embodiment 1 comprises the binder containing 1,2-bis(trihydroxysilyl)alkane, the photocatalyst layer 5 can be formed without carrying out a hydrolysis treatment during the photocatalyst layer formation step.

The coating agent 2 of Embodiment 1 comprises the binder containing 1,2-bis(trihydroxysilyl)alkane. By drying the coating agent 2 (the application layer 4), 1,2-bis(trihydroxysilyl)alkane or a product of dehydration-condensation reaction of 1,2-bis(trihydroxysilyl)alkane dehydrates and condenses with the photocatalyst particles; and 1,2-bis(trihydroxysilyl)alkane or a product of dehydration-condensation reaction of 1,2-bis(trihydroxysilyl)alkane dehydrates and condenses with the base material 3, so as to generate a siloxane compound. The covalent bonds formed by these dehydration-condensation reactions firmly bond the photocatalyst particles and the base material 3 via the binder (the siloxane compound). The strong bonding improves the water resistance and the durability of the photocatalyst coated body 10 having the photocatalyst layer 5 formed from the coating agent 2 of Embodiment 1. Because of its excellent water resistance and durability, the photocatalyst coated body 10 produced by the preparation method of Embodiment 3 can suitably exhibit photocatalytic activities in any environment, such as indoors, outdoors, in air, and in water.

The method for applying the coating agent 2 onto the base material 3 is not particularly limited. Examples of how to apply the coating agent 2 onto the base material 3 include spin coating, dip coating, spray coating, roll coating, gravure coating, wire bar coating, air knife coating, and ink jet coating. The coating agent 2 may be applied at least partially on the base material 3. The thickness of the photocatalyst layer 5 formed is not particularly limited. The thickness of the photocatalyst layer 5 obtained by any coating method can achieve the effect of the coating agent 2 of Embodiment 1.

The method for drying the coating agent 2 (the application layer 4) applied on the base material 3 is not particularly limited. Examples of how to dry the coating agent 2 (the application layer 4) applied on the base material 3 include room temperature drying, through-flow drying, forced drying using a dryer, and calcination. The temperature at which the coating agent 2 (the application layer 4) applied on the base material 3 is dried is preferably 20° C. or higher to 150° C. or lower.

Before the coating agent 2 is applied onto the base material 3, it is preferable that a surface of the base material 3 should be modified to be hydrophilic. By modifying the surface of the base material 3 to be hydrophilic, wettability of the coating agent 2 on the base material 3 can be improved to form a photocatalyst layer 5 with a more uniform thickness.

Examples of how to modify the surface of the base material 3 to be hydrophilic include chemical treatment, mechanical treatment, corona treatment, flame treatment, UV irradiation treatment, high frequency treatment, glow discharge treatment, plasma treatment, laser treatment, mixed acid treatment, and ozone oxidation treatment. Another example of how to modify the surface of the base material 3 to be hydrophilic is to form a primer layer on the base material 3 by applying a primer on the base material 3. Among these methods, the plasma treatment, the UV irradiation treatment, the corona treatment, and the glow discharge treatment are preferred; and the UV irradiation treatment is more preferred.

An example of the UV irradiation treatment will be described below. Using a device that emits ultraviolet rays, the surface of the base material 3 is irradiated with the ultraviolet rays. In this way, before the coating agent 2 is applied on the base material 3, the surface of the base material 3 is irradiated with the ultraviolet light to modify the surface of the base material 3 to be hydrophilic. To easily modify the surface of the base material 3 to be hydrophilic, the wavelength of UV light is preferably 150 nm or more to 350 nm or less, and more preferably 200 nm or more to 300 nm or less. The device for emitting the ultraviolet rays is not particularly limited, and any known device may be used as needed. Examples of the UV light source include a low-pressure mercury vapor lamp and an excimer lamp. The wavelengths (k) of the ultraviolet light emitted from the low-pressure mercury lamp are, for example, 254 nm and 185 nm. The wavelength (k) of the ultraviolet light emitted from the excimer lamp is, for example, at least one of the following wavelengths: 308 nm (XeCl* lamp), 227 nm (KrCl* lamp), 172 nm (Xe₂* lamp), 126 nm (Ar₂* lamp), and 146 nm (Kr₂* lamp). The duration of the UV irradiation depends on irradiance and irradiation conditions but is, for example, from 1 minute to 1 hour.

### Preparation of Photocatalyst Coating Agent

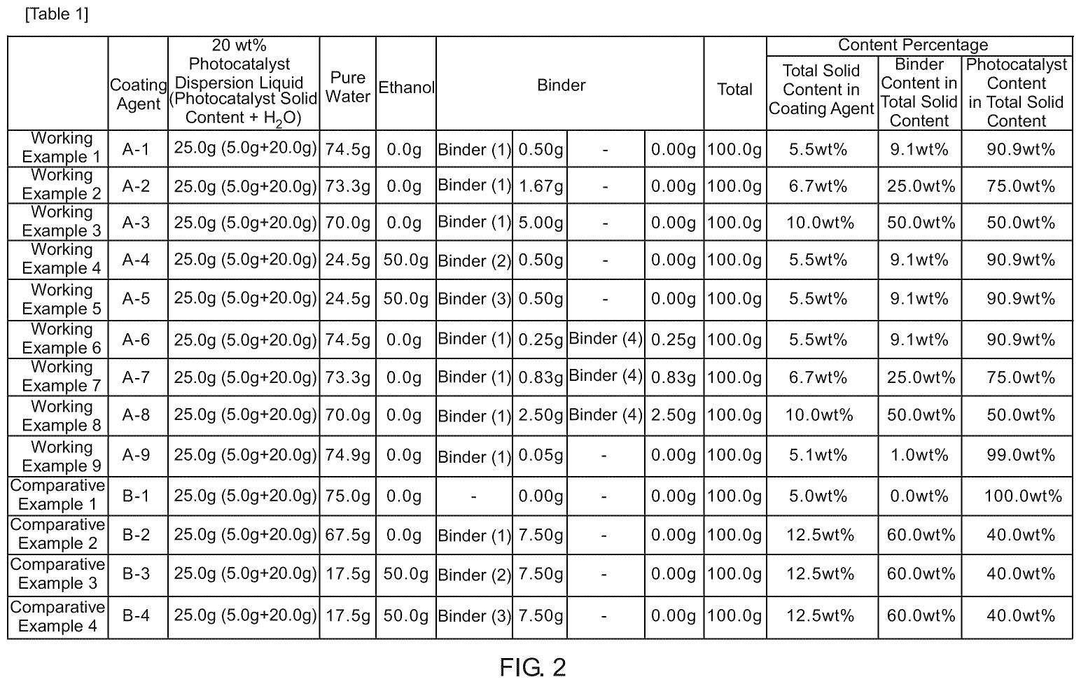

photocatalyst coating agents A-1 to A-9 and B-1 to B-4 were prepared whose materials are shown in Table 1 of FIG. 2.

In Table 1 of FIG. 2, “20 wt % photocatalyst dispersion liquid” indicates a suspension (dispersion medium: water) containing 20 wt % photocatalyst particles including tungsten oxide particles and platinum particles supported on the tungsten oxide particles. A 20 wt % photocatalyst dispersion liquid was prepared by the following method. More specifically, 200 g of tungsten oxide (manufactured by KISHIDA CHEMICAL Co., Ltd.) was mixed with 1,000 mL of pure water; and the tungsten oxide was dispersed while the mixture was irradiated with ultrasonic waves to obtain dispersion liquid A of tungsten oxide particles. A hexachloroplatinum (VI)·6 hydrate (manufactured by KISHIDA CHEMICAL Co., Ltd.; 98.5% purity) was dissolved in the dispersion liquid A to obtain dispersion liquid B of tungsten oxide particles. The amount of the hexachloroplatinum (VI)·6 hydrate added was such that the ratio of a mass of platinum alone to a mass of the tungsten oxide particles was 0.05 mass %. The dispersion liquid B was heated at 100° C. to evaporate water and then calcined to obtain 0.05 wt % platinum supporting tungsten oxide particles. Then, pure water was added to the 0.05 wt % platinum supporting tungsten oxide particles so that the ratio of the 0.05 wt % platinum supporting tungsten oxide particles became 20 mass %, thereby preparing the 20 wt % photocatalyst dispersion liquid. The average particle diameter of the 0.05 wt % platinum supporting tungsten oxide particles in the 20 wt % photocatalyst dispersion liquid was 175 nm. Table 1 of FIG. 2 also shows mass of photocatalyst solid content and mass of water in the 20 wt % photocatalyst dispersion liquid. The photocatalyst solid content are solids remaining when the 20 wt % photocatalyst dispersion liquid is allowed to dry at 100° C.

As binders to be contained in the photocatalyst coating agents, binders (1) to (4) were used. Table 1 of FIG. 2 shows the binders contained in the photocatalyst coating agents each. A photocatalyst coating agent B-1 contains no binder.

A binder (1) is 1,2-bis(triethoxysilyl)ethane, which is a raw material of 1,2-bis(trihydroxysilyl)ethane. When 1,2-bis(triethoxysilyl)ethane is mixed with the photocatalyst dispersion liquid and pure water, 1,2-bis(triethoxysilyl)ethane is hydrolyzed to be 1,2-bis(trihydroxysilyl)ethane because the mixture is acidic.

A binder (2) is 1,2-bis(trimethoxysilyl)hexane, which is a raw material of 1,2-bis(trihydroxysilyl)hexane. When 1,2-bis(trimethoxysilyl)hexane is mixed with the photocatalyst dispersion liquid and pure water, 1,2-bis(trimethoxysilyl)hexane is hydrolyzed to be 1,2-bis(trihydroxysilyl)hexane because the mixture is acidic.

A binder (3) is 1,2-bis(trimethoxysilyl)octane, which is a raw material of 1,2-bis(trihydroxysilyl)octane. When 1,2-bis(trimethoxysilyl)octane is mixed with the photocatalyst dispersion liquid and pure water, 1,2-bis(trimethoxysilyl)octane is hydrolyzed to be 1,2-bis(trihydroxysilyl)octane because the mixture is acidic.

A binder (4) is 3-methacryloxypropyltriethoxysilane, which is a raw material of 3-methacryloxypropyltrihydroxysilane. When 3-methacryloxypropyltriethoxysilane is mixed with the photocatalyst dispersion liquid and pure water, 3-methacryloxypropyltriethoxysilane is hydrolyzed to be 3-methacryloxypropyltrihydroxysilane because the mixture is acidic.

A punctuation mark “-” in Table 1 of FIG. 2 indicates that the coating agent does not contain any applicable material.

A category “total solid content in coating agent” in Table 1 of FIG. 2 indicates a percentage of a mass of total solid content in a mass of a photocatalyst coating agent. The total solid content indicates solids remaining when the photocatalyst coating agent is allowed to dry at 100° C.

A category “binder content in total solid content” in Table 1 of FIG. 2 indicates a percentage of a mass of a binder in a mass of total solid content in a photocatalyst coating agent.

A category “photocatalyst content in total solid content” in Table 1 of FIG. 2 indicates a percentage of a mass of a photocatalyst in a mass of total solid content in a photocatalyst coating agent.

Coating agents each were prepared as follows.

### Preparation of Coating Agent (A-1)

As per the blending amounts shown in Table 1 of FIG. 2, the following materials were mixed: 1,2-bis(triethoxysilyl)ethane (binder (1)), which is a raw material of 1,2-bis(trihydroxysilyl)ethane; pure water; and a 20 wt % photocatalyst dispersion liquid prepared as described above (content percentage of platinum-supporting tungsten oxide particles: 20 mass %), obtaining 100 g of a coating agent (A-1) with a total solid content percentage of 5.5 mass %.

### Preparation of Coating Agent (A-2)

As per the blending amounts shown in Table 1 of FIG. 2, the following materials were mixed: 1,2-bis(triethoxysilyl)ethane (binder (1)), which is a raw material of 1,2-bis(trihydroxysilyl)ethane; pure water; and a 20 wt % photocatalyst dispersion liquid prepared as described above (content percentage of platinum-supporting tungsten oxide particles: 20 mass %), obtaining 100 g of a coating agent (A-2) with a total solid content percentage of 6.7 mass %.

### Preparation of Coating Agent (A-3)

As per the blending amounts shown in Table 1 of FIG. 2, the following materials were mixed: 1,2-bis(triethoxysilyl)ethane (binder (1)), which is a raw material of 1,2-bis(trihydroxysilyl)ethane; pure water; and a 20 wt % photocatalyst dispersion liquid prepared as described above (content percentage of platinum-supporting tungsten oxide particles: 20 mass %), obtaining 100 g of a coating agent (A-3) with a total solid content percentage of 10.0 mass %.

### Preparation of Coating Agent (A-4)

As per the blending amounts shown in Table 1 of FIG. 2, the following materials were mixed: 1,2-bis(trimethoxysilyl)hexane (binder (2)), which is a raw material of 1,2-bis(trihydroxysilyl)hexane; pure water; and a 20 wt % photocatalyst dispersion liquid prepared as described above (content percentage of platinum-supporting tungsten oxide particles: 20 mass %), obtaining 100 g of a coating agent (A-4) with a total solid content percentage of 5.5 mass %.

### Preparation of Coating Agent (A-5)

As per the blending amounts shown in Table 1 of FIG. 2, the following materials were mixed: 1,2-bis(trimethoxysilyl)octane (binder (3)), which is a raw material of 1,2-bis(trihydroxysilyl)octane; pure water; and a 20 wt % photocatalyst dispersion liquid prepared as described above (content percentage of platinum-supporting tungsten oxide particles: 20 mass %), obtaining 100 g of a coating agent (A-5) with a total solid content percentage of 5.5 mass %.

### Preparation of Coating Agent (A-6)

As per the blending amounts shown in Table 1 of FIG. 2, the following materials were mixed: 1,2-bis(triethoxysilyl)ethane (binder (1)), which is a raw material of 1,2-bis(trihydroxysilyl)ethane; 3-methacryloxypropyltriethoxysilane (binder (4)), which is a raw material of 3-methacryloxypropyltrihydroxysilane; pure water; and a 20 wt % photocatalyst dispersion liquid prepared as described above (content percentage of platinum-supporting tungsten oxide particles: 20 mass %), obtaining 100 g of a coating agent (A-6) with a total solid content percentage of 5.5 mass %.

### Preparation of Coating Agent (A-7)

As per the blending amounts shown in Table 1 of FIG. 2, the following materials were mixed: 1,2-bis(triethoxysilyl)ethane (binder (1)), which is a raw material of 1,2-bis(trihydroxysilyl)ethane; 3-methacryloxypropyltriethoxysilane (binder (4)), which is a raw material of 3-methacryloxypropyltrihydroxysilane; pure water; and a 20 wt % photocatalyst dispersion liquid prepared as described above (content percentage of platinum-supporting tungsten oxide particles: 20 mass %), obtaining 100 g of a coating agent (A-7) with a total solid content percentage of 6.7 mass %.

### Preparation of Coating Agent (A-8)

As per the blending amounts shown in Table 1 of FIG. 2, the following materials were mixed: 1,2-bis(triethoxysilyl)ethane (binder (1)), which is a raw material of 1,2-bis(trihydroxysilyl)ethane; 3-methacryloxypropyltriethoxysilane (binder (4)), which is a raw material of 3-methacryloxypropyltrihydroxysilane; pure water; and a 20 wt % photocatalyst dispersion liquid prepared as described above (content percentage of platinum-supporting tungsten oxide particles: 20 mass %), obtaining 100 g of a coating agent (A-8) with a total solid content percentage of 10.0 mass %.

### Preparation of Coating Agent (A-9)

As per the blending amounts shown in Table 1 of FIG. 2, the following materials were mixed: 1,2-bis(triethoxysilyl)ethane (binder (1)), which is a raw material of 1,2-bis(trihydroxysilyl)ethane; pure water; and a 20 wt % photocatalyst dispersion liquid prepared as described above (content percentage of platinum-supporting tungsten oxide particles: 20 mass %), obtaining 100 g of a coating agent (A-9) with a total solid content percentage of 5.1 mass %.

### Preparation of Coating Agent (B-1)

As per the blending amounts shown in Table 1 of FIG. 2, the following materials were mixed: pure water and a 20 wt % photocatalyst dispersion liquid prepared as described above (content percentage of platinum-supporting tungsten oxide particles: 20 mass %), obtaining 100 g of a coating agent (B-1) with a total solid content percentage of 5.0 mass %. The coating agent (B-1) contains no binder.

### Preparation of Coating Agent (B-2)

As per the blending amounts shown in Table 1 of FIG. 2, the following materials were mixed: 1,2-bis(triethoxysilyl)ethane (binder (1)), which is a raw material of 1,2-bis(trihydroxysilyl)ethane; pure water; and a 20 wt % photocatalyst dispersion liquid prepared as described above (content percentage of platinum-supporting tungsten oxide particles: 20 mass %), obtaining 100 g of a coating agent (B-2) with a total solid content percentage of 12.5 mass %.

### Preparation of Coating Agent (B-3)

As per the blending amounts shown in Table 1 of FIG. 2, the following materials were mixed: 1,2-bis(trimethoxysilyl)hexane (binder (2)), which is a raw material of 1,2-bis(trihydroxysilyl)hexane; pure water; and a 20 wt % photocatalyst dispersion liquid prepared as described above (content percentage of platinum-supporting tungsten oxide particles: 20 wt %), obtaining 100 g of a coating agent (B-3) with a total solid content percentage of 12.5 mass %.

### Preparation of Coating Agent (B-4)

As per the blending amounts shown in Table 1 of FIG. 2, the following materials were mixed: 1,2-bis(trimethoxysilyl)octane (binder (3)), which is a raw material of 1,2-bis(trihydroxysilyl)octane; pure water; and a 20 wt % photocatalyst dispersion liquid prepared as described above (content percentage of platinum-supporting tungsten oxide particles: 20 mass %), obtaining 100 g of a coating agent (B-4) with a total solid content percentage of 12.5 mass %.

### Evaluation Method and Evaluation Results

### Formation of Photocatalyst Bodies for Evaluation

The photocatalyst coating agents (A-1) to (A-9) and (B-1) to (B-4) were used to form photocatalyst bodies (A-1) to (A-9) and (B-1) to (B-4) for evaluation, each of the photocatalyst bodies having the photocatalyst layer on the substrate. Two types of substrates, substrate (1) and substrate (2), as will be described below, were used to form the photocatalyst bodies for evaluation:
Substrate (1): alkali-free glass (50 mm long×50 mm wide×0.5 mm thick)
Substrate (2): tile (“ecocarat fine base simple” manufactured by LIXIL Corporation)

In a water resistance test and a durability test, the photocatalyst bodies for evaluation in which the photocatalyst layer is placed on the substrate (1) were tested; and in a methylene blue degradation test, the photocatalyst bodies for evaluation in which the photocatalyst layer is placed on the substrate (2) were tested.

By using an ultraviolet ozone irradiation device (model: UV-312 manufactured by Technovision, Inc.) equipped with a low-pressure mercury lamp, the substrates were subjected to a treatment (UV ozone cleaning treatment) in which the substrates are irradiated with ultraviolet rays for 30 minutes. In this way, surfaces of the substrates were modified to be hydrophilic. Next, the photocatalyst coating agent was applied several times to the substrates using a trigger sprayer to form an application layer so that the weight of a photocatalyst layer per unit area would become 5.0 g/m²; and the application layer was allowed to dry at 100° C. for 1 hour to form a photocatalyst layer. In this way, photocatalyst bodies for evaluation, each of which having the photocatalyst layer on the substrate, were obtained.

### Water Resistance Test

The photocatalyst bodies (A-1) to (A-9) and (B-1) to (B-4) having the photocatalyst layer on the substrate (1) were tested for water resistance by the following method. More specifically, 100 mL of water was poured into a 500 mL capacity glass container; and the photocatalyst bodies for evaluation having the photocatalyst layer on the substrate (1) were immersed in the water. The photocatalyst bodies to be evaluated were left immersed in the water for 24 hours at a water temperature of 20° C. After being taken out of the water and allowed to dry at 100° C. for 24 hours, the photocatalyst bodies each were measured for mass.

A mass of a portion (peeled portion) of the photocatalyst body peeled (or detached) from the photocatalyst layer by the immersion in the water was calculated from a difference between a mass of the photocatalyst body before being immersed in the water and a mass of the photocatalyst body after being taken out of the water and allowed to dry. Also, peeling rates (unit: mass %) were calculated using a formula: “peeling rate=100×mass of peeled portion/mass of photocatalyst layer before water resistance test.” From the calculated peeling rates, the photocatalyst bodies for evaluation were evaluated for water resistance in accordance with the following criteria.

The photocatalyst bodies with the peeling rates from 0% or more to less than 10% were evaluated as “very good”; and those with the peeling rates of 10% or more were evaluated as “poor.”

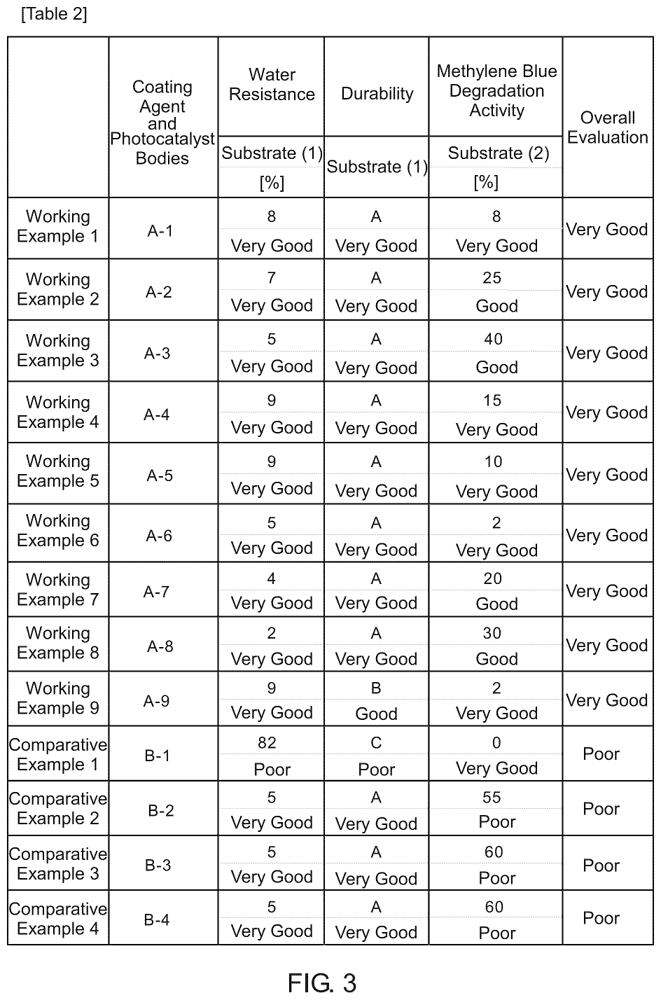

The peeling rates and the evaluation results for the photocatalyst bodies (A-1) to (A-9) and (B-1) to (B-4) for evaluation having the photocatalyst layer on the substrate (1) are shown in Table 2 of FIG. 3.

Since the photocatalyst coating agent (B-1) does not contain any binder, it is considered that the water resistance evaluation of the photocatalyst body (B-1) resulted in “poor.”

The water resistance evaluation of the photocatalyst bodies (A-1) to (A-9) and (B-2) to (B-4) each resulted in “very good.” Therefore, it was found that the photocatalyst coating agent and the photocatalyst layer containing the above binders can improve the water resistance of the photocatalyst layer.

### Durability Test

After the water resistance test, a durability test was conducted on the photocatalyst bodies (A-1) to (A-9) and (B-1) to (B-4) using a method to be described below. The photocatalyst bodies tested for the water resistance were allowed to dry at 40° C. for 24 hours. After drying, four strips of mending tape (Model No: 810-3-12 manufactured by 3M Japan Limited, which was cut to a length of 50 mm and a width of 12 mm) were pasted in parallel to a surface of the photocatalyst layer of the photocatalyst bodies each for evaluation. The four strips of mending tape were then peeled off from the surface of the photocatalyst layer. Contact surfaces of the four strips of mending tape that had been peeled off were visually observed to see (check) if there are any pieces of the photocatalyst layer adhered to the mending tape. Based on this observation, the photocatalyst bodies (A-1) to (A-9) and (B-1) and (B-4) were evaluated for durability.

The evaluation of the durability of the photocatalyst bodies (A-1) to (A-9) and (B-1) to (B-4) is shown in Table 2 of FIG. 3. Evaluation criteria for the durability are described below.
Evaluation A (very good): No pieces of the peeled photocatalyst layer were observed on any of the four strips of mending tape.
Evaluation B (good): Pieces of the peeled photocatalyst layer were observed on one of the four strips of mending tape.
Evaluation C (poor): Pieces of the peeled photocatalyst layer were observed on two or more of the four strips of mending tape.

Since the photocatalyst coating agent (B-1) does not contain any binder, it is considered that the durability evaluation of the photocatalyst body (B-1) resulted in “poor.”

The durability evaluation of the photocatalyst bodies (A-1) to (A-9) and (B-2) to (B-4) each resulted in “very good” or “good.” Therefore, it was found that the photocatalyst coating agent and the photocatalyst layer containing the above binders can improve the durability of the photocatalyst layer.

### Methylene Blue Degradation Test

Using a method to be described below, the photocatalyst bodies (A-1) to (A-9) and (B-1) to (B-4) for evaluation, each of which has the photocatalyst layer on the substrate (2), were subjected to a methylene blue degradation test (measurement of a methylene blue fading rate), which is a confirmation test of photocatalytic activities.

More specifically, 20 μL of a methylene blue solution with a concentration of 100 μmol/L was dropped onto the photocatalyst layer of the photocatalyst bodies using a micropipette. After the dropping of the methylene blue solution, the photocatalyst bodies for evaluation were allowed to dry at room temperature. Next, the photocatalyst bodies for evaluation were continuously irradiated with ultraviolet light with an emission peak of 365 nm and an irradiance of 2.5 mW/cm² for 24 hours using a UV lamp. A fading rate was calculated by measuring a reflection density of methylene blue dropped on the photocatalyst layer of the photocatalyst bodies for evaluation. More specifically, the reflection density of methylene blue on the photocatalyst layer was measured using a black-and-white reflection densitometer (R700 manufactured by Ihara Electronic Co., Ltd.); and then a difference in reflectance δd (unit: %) was determined to calculate a fading rate of methylene blue.

The fading of methylene blue is caused by photolysis of the methylene blue that was dropped onto the photocatalyst layer of the photocatalyst bodies for evaluation. The smaller the reflectance difference δd, which indicates the fading rate of the methylene blue, the better a methylene blue degradation activity of the photocatalyst layer formed of the coating agent.

Table 2 of FIG. 3 shows evaluation results of the methylene blue fading rate measured from the photocatalyst bodies (A-1) to (A-9) and (B-1) to (B-4) for evaluation using the substrate (2) and of the methylene blue degradation activity of each photocatalyst body.

Evaluation criteria for the methylene blue degradation test are described below.
Very good: Reflectance difference δd is less than 20%.
Good: Reflectance difference δd is 20% or more to less than 50%.
Poor: Reflectance difference δd is 50% or more to less than 100%.

The results of overall evaluation of the photocatalyst bodies (A-1) to (A-9) and (B-1) to (B-4) are shown in Table 2 of FIG. 3. Evaluation criteria for the overall evaluation are also described below.
Very good: There are no poor evaluations in the water resistance test, the durability test, and the methylene blue degradation test.
Poor: There is at least one poor evaluation in the water resistance test, the durability test, and the methylene blue degradation test.

The photocatalyst body (B-1) for evaluation was evaluated as “very good” with respect to the methylene blue degradation activity. Since the coating agent (B-1) and the photocatalyst layer of the photocatalyst body (B-1) do not contain any binder, it is considered that the methylene blue degradation activity was evaluated as high. However, the water resistance evaluation and the durability evaluation of the photocatalyst body (B-1) were “poor”; therefore, the overall evaluation of the photocatalyst body (B-1) for evaluation resulted in “poor.”

The photocatalyst bodies (B-2) to (B-4) for evaluation were evaluated as “poor” with respect to the methylene blue degradation activity. Since the photocatalyst layer of the photocatalyst bodies (B-2) to (B-4) each contains a 60 wt % binder, it is considered that the photocatalyst is buried in the binder, resulting in a low evaluation of the methylene blue degradation activity. The overall evaluation of the photocatalyst bodies (B-2) to (B-4) resulted in “poor.”

The photocatalyst bodies (A-1) to (A-9) were evaluated as “very good” or “good” with respect to the methylene blue degradation activity. Also, the photocatalyst bodies (A-1) to (A-9) were evaluated as “very good” with respect to the water resistance, and were evaluated as “very good” or “good” with respect to the durability. Therefore, it was found that the overall evaluation of the photocatalyst bodies (A-1) to (A-9) resulted in “very good,” indicating that these photocatalyst bodies are excellent in water resistance and durability, and are high in methylene blue degradation activity.

What is claimed is:

1. A photocatalyst coating agent comprising at least: photocatalyst particles containing tungsten oxide; a first binder; and water, wherein the first binder is 1,2-bis(trihydroxysilyl)alkane represented by a chemical formula: (HO)₃Si—(CH₂)ₙ—Si(OH)₃.

2. The photocatalyst coating agent according to claim 1, wherein the content percentage of the photocatalyst particles is 50 mass % or more to 99 mass % or less when the mass of a total solid content in the photocatalyst coating agent is 100 mass %.

3. The photocatalyst coating agent according to claim 1, wherein the content percentage of the first binder is 1 mass % or more to 50 mass % or less when the mass of the total solid content in the photocatalyst coating agent is 100 mass %.

4. The photocatalyst coating agent according to claim 1, wherein the first binder is 1,2-bis(trihydroxysilyl)alkane in which the number of carbon atoms n is 2 to 8.

5. The photocatalyst coating agent according to claim 1, further comprising a second binder, wherein the second binder is a compound having a hydroxysilyl group.

6. The photocatalyst coating agent according to claim 5, wherein the second binder is the compound having a methacryloxy group.

7. The photocatalyst coating agent according to claim 5, wherein the sum of the content percentage of the first binder and the content percentage of the second binder is 1 mass % or more to 50 mass % or less when the mass of the total solid content in the photocatalyst coating agent is 100 mass %.

8. The photocatalyst coating agent according to claim 1, further comprising an antiseptic, wherein the antiseptic is ethanol.

9. The photocatalyst coating agent according to claim 1, wherein the photocatalyst coating agent is a suspension containing the first binder, the photocatalyst particles, and water.

10. A photocatalyst coated body comprising a base material and a photocatalyst layer placed on the base material, wherein
the photocatalyst layer contains photocatalyst particles and a siloxane compound containing a product of dehydration-condensation reaction of 1,2-bis(trihydroxysilyl)alkane represented by a chemical formula: (HO)₃Si—(CH₂)ₙ—Si(OH)₃.

11. A photocatalyst coating method comprising: applying the photocatalyst coating agent according to claim 1 onto a base material to form an application layer; and allowing the application layer to dry.
